(19) United States
(12) Patent Application Publication
(10) Pub. No.: US 2016/0030956 A1
(43) Pub. Date: Feb. 4, 2016

(54) LIQUID DISPENSER WITH INTERNAL HELICAL SCREW

(71) Applicant: 0985438 B.C. Ltd., Burnaby (CA)

(72) Inventors: Nicholas Udovicic, Burnaby (CA); Sylvain Leone, Kelowna (CA)

(73) Assignee: 0985438 B.C. Ltd., Burnaby (CA)

(21) Appl. No.: 14/547,533

(22) Filed: Nov. 19, 2014

(30) Foreign Application Priority Data
Jul. 29, 2014 (CA) 2858214

(51) Int. Cl. B05B 1/34

(52) U.S. Cl. CPC B05B 1/3468

(57) ABSTRACT

A liquid dispenser that revitalizes the liquid and restores the natural structure, health and vitality to the liquid by increasing and activating dissolved oxygen in the liquid. The liquid dispenser may have an elongated open-ended chamber body. The body may have a distal and proximal end with the proximal end configured to receive a stream of liquid and the distal end configured to expel the stream of liquid. A helical screw may be connected inside of the elongated chamber body. The helical screw may be configured to transport the stream of water from the proximal end to the distal end of the chamber.

### FIELD OF THE INVENTION

The invention relates to the field of liquid conduits and in particular to a liquid dispenser having an internal helical screw.

### BACKGROUND OF THE INVENTION

Water nozzles have been in existence for some time. Typically, these nozzles are attached to an end of a hose and a trigger is employed that allows water to travel from the hose out to an exit of a water gun nozzle.

Various theories exist regarding the efficacies of utilizing a vortex to revitalize water. According to these theories, the absorption of revitalized water provides one's body with energy and improves one's overall digestive system; hence, resulting in better elimination of bodily waste. It is also theorized that revitalized water efficiently transports nutrients to the body's cells and transports waste products and toxins out of the cells.

Theories also abound regarding the use of magnets in improving the overall efficacy of water. These theories espouse the notion that by passing water through a magnetic density field, the molecules in the water, begin to sort themselves, or self organize, in the field of the magnets. It is believed that this structuring of the molecules makes the water more bioavailable for consumption.

Accordingly, it would be highly desirable to provide a liquid dispenser that revitalizes liquid and restores the natural structure, health and vitality to the liquid by increasing and activating dissolved oxygen in the liquid through the use of a vortex and magnets.

### SUMMARY OF THE INVENTION

According to the present invention there is provided a liquid dispenser that revitalizes the liquid and restores the natural structure, health and vitality to the liquid by increasing and activating dissolved oxygen in the liquid. The liquid dispenser may have an elongated open-ended chamber body. The chamber body may have a distal and proximal end with the proximal end configured to receive a stream of liquid and the distal end configured to expel the stream of liquid. A helical screw may be connected inside of the elongated chamber body. The helical screw may be configured to transport the stream of water from the proximal end through to the distal end of the chamber body.

The liquid dispenser may also include a magnet connected inside of the elongated chamber body adjacent the helical screw. The magnet may also be connected adjacent to the proximal end of the chamber body.

Activation means connected to the chamber body may also be included. In a first position, the activation means may inhibit the stream of liquid from flowing through the chamber body. In a second position, the activation means may allow the stream of liquid to flow through the chamber body. More specifically, the activation means may include a lever pivotably connected to the chamber body. A flow engagement device may be in mechanical communication with the lever and oriented in the chamber body to inhibit the stream of liquid from flowing through the chamber body in the first position. Additionally, the activation means may include a biaser to bias the flow engagement device into the first position.

The liquid dispenser may also include retention means connected to the chamber body for retaining the activation means in the second position. The retention means may be a ring connected to the chamber body that is configured to slide over the lever.

Other aspects of the invention will be appreciated by reference to the detailed description of the preferred embodiment and to the claims that follow.

### BRIEF DESCRIPTION OF THE DRAWINGS

The preferred embodiment of the invention will be described by reference to the drawings thereof in which:

FIG. 1 is a perspective view of a liquid dispenser of the present invention in a first closed position;

FIG. 2 is a perspective view of the liquid dispenser of the present invention in a second open position;

FIG. 3 is a cutaway view along line 1-1 of FIG. 1;

FIG. 4 is a cutaway view along line 2-2 of FIG. 2;

FIG. 5 is an exploded cutaway view along line 1-1 of FIG. 1;

FIG. 6 is the liquid dispenser of FIG. 4 showing a liquid flow path in the first closed position; and

FIG. 7 is the liquid dispenser of FIG. 5 showing a liquid flow path in the second open position.

### DESCRIPTION OF THE PREFERRED EMBODIMENT OF THE INVENTION

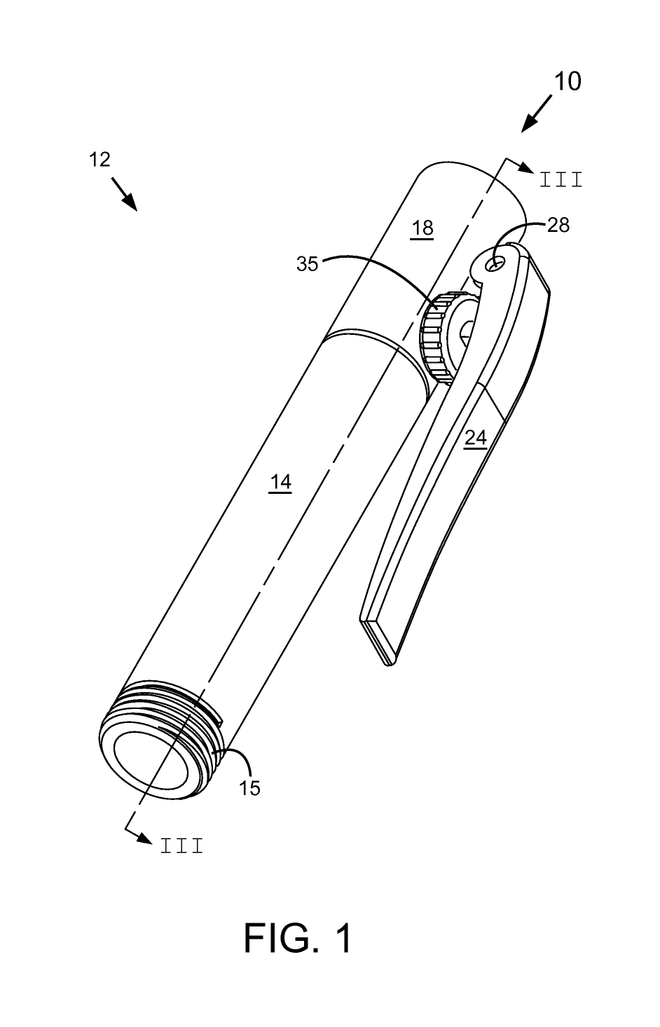

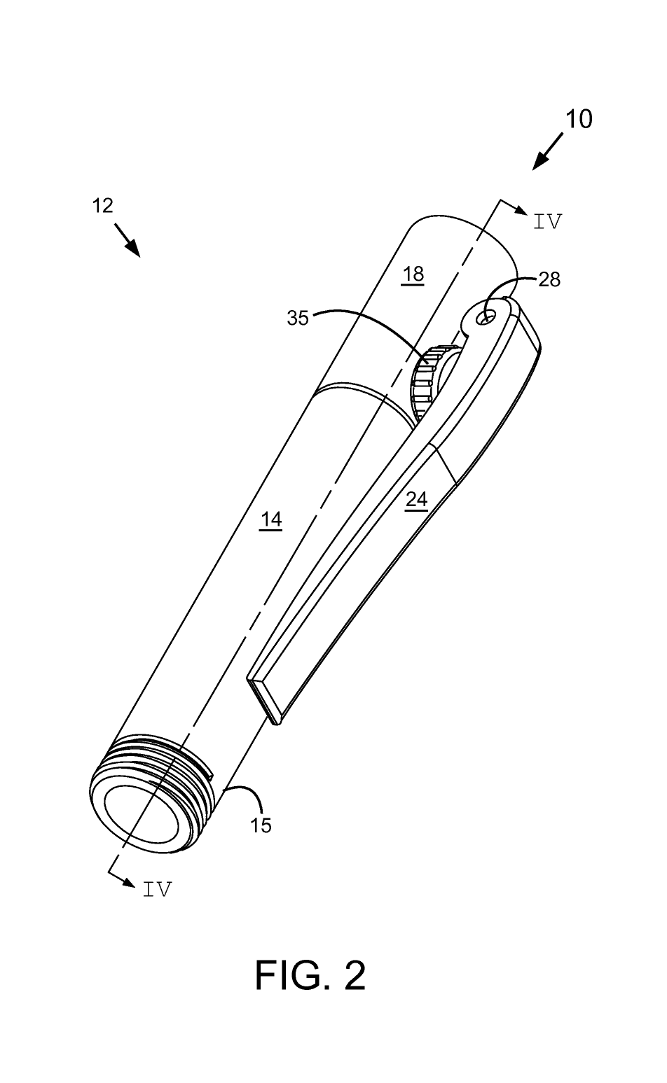

Referring to FIGS. 1 and 2, there is provided a liquid dispenser 10. Liquid dispenser 10 is operable in two positions: a first closed position, as illustrated by FIG. 1 and a second open position, as illustrated by FIG. 2.

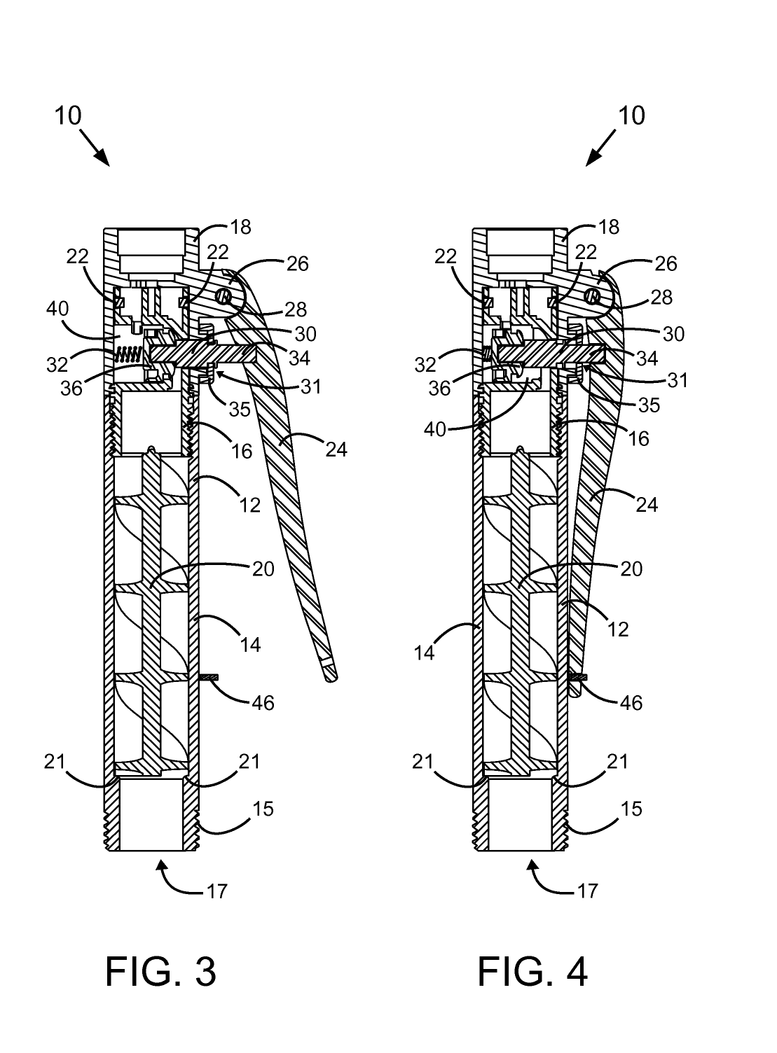

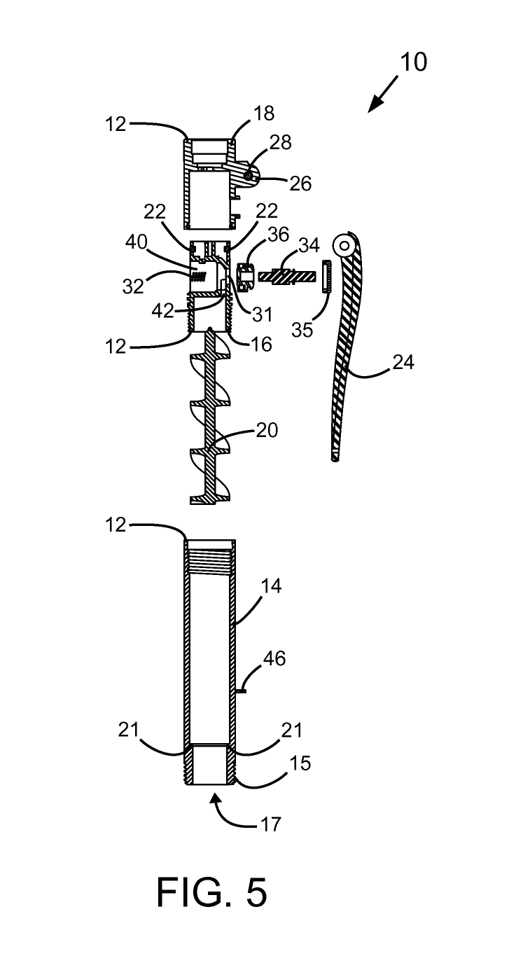

Referring to FIGS. 3, 4 and 5, liquid dispenser 10 has an elongated open-ended chamber body 12. As those skilled in the art will appreciate, chamber body 12 may be a singular body, but in the preferred embodiment is constructed with a barrel body 14, a manifold body 16 and a rear fitting body 18, each of which are configured to attach to one another to create a fluidic seal. Chamber body 12 has a distal end represented by rear fitting body 18 and a proximal end represented by barrel body 14. Rear fitting body 18 is configured to receive a stream of liquid, for example, from a hose (not depicted) and barrel body 14 is configured to expel the stream of liquid through an exit 17. Barrel body 14 may include means, such as threads 15 to attach an attachment, such as a garden wand (not depicted) to its exit 17.

A helical screw 20 is provided which is connected to the inside of chamber body 12. Helical screw 20 is configured to transport the stream of water from rear fitting body 18 through barrel body 14 and out exit 17. In the preferred embodiment, helical screw 20 is permanently connected at one end to manifold body 16 through conventional techniques. In constructing chamber body 12, helical screw 20 is merely inserted into barrel body 14 and its free end then abuts an internal shoulder 21 inside of barrel body 14. Shoulder 21 is configured to lock the free end of helical screw 20 so that the helical screw is further prevented from rotating within barrel body 14. In the preferred embodiment, helical screw 20 is a two start thread with a pitch of 1″ and a lead of 2″.The small minor diameter creates a thread depth of approximately ⅜″, which allows ample flow of water through helical screw 20 as the liquid enters from manifold chamber exit 42.

Liquid dispenser 10 also includes magnets 22 connected inside of chamber body 12 and in particular, manifold body 16. Magnets are seated opposite each other in manifold body 16 in two small recesses (not illustrated). and are locked in place when rear fitting body 18 is placed over the manifold body. To control the flow of liquid through liquid dispenser 10, activation means connected to chamber body 12 is also included. In particular, activation means includes a lever 24. Lever 24 is conventionally pivotably connected to chamber body 12, and in the preferred embodiment, to pivot point 26 on rear fitting body 18 via a pin 28. A flow engagement device or piston 30 is oriented in chamber 12, and in the preferred embodiment, inside manifold body 16 to be in mechanical communication with lever 24 through top hole 31 in manifold body 16. A biaser 32, such as a coil spring, is provided inside manifold body 16 to bias piston 30 into the first closed position. Piston 30 includes a piston shaft 34 and piston head 36. Piston shaft 34 is a smaller diameter than manifold chamber 40, whereas piston head 36 may be substantially the same diameter as manifold chamber 40.

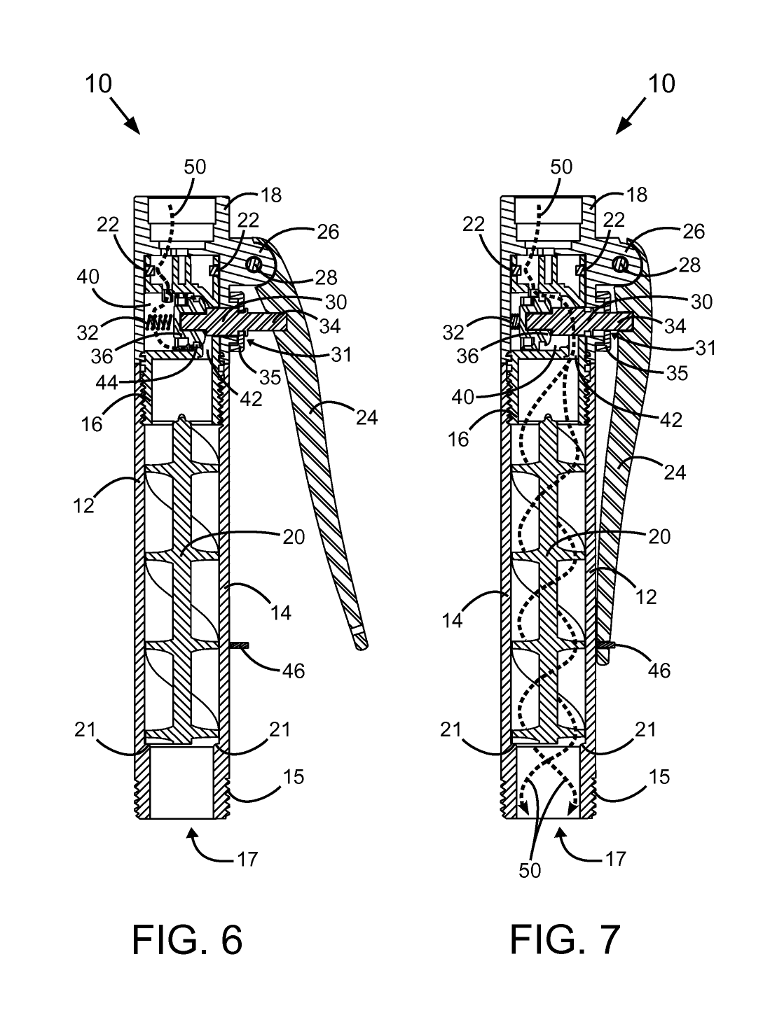

Referring to FIG. 6, in a first closed position, biaser 32 biases piston shaft 34 and piston head 36 upward to engage lever 24. Piston head 36 in manifold chamber 40 effectively cuts off manifold chamber exit 42 from manifold body 16 through to barrel body 14. In this position, liquid stream 50 merely swirls around manifold chamber 40 and is prevented from exiting manifold body 16. In a preferred embodiment, piston head 36 includes an o-ring 44 to create an effective water-tight seal between manifold body 16, manifold chamber exit 42 and barrel body 14. Referring to FIG. 7, when lever 24 is depressed into the second open position, the lever pushes down onto piston shaft 30 and piston head 36 which, in turn, pushes down onto biaser 32. Here, piston head 36 in manifold chamber 40 no longer cuts off manifold chamber exit 42 from manifold body 16 through to barrel body 14. In this position, liquid stream 50 is allowed to exit from manifold body 16 through manifold chamber exit 42, into barrel body 14 with into contact with helical screw 20 and out exit 17. In the open position, liquid stream passes into rear fitting body 18, across magnets 22 and into manifold body 16 where it then exits through manifold chamber exit 42. Upon exiting manifold body 16, liquid stream 50 rides across helical screw 20 and exits barrel body 16 through exit 17. Through contact with magnets 22 and helical screw 20, liquid 50 is revitalized and restored to its natural structure and the health and vitality of the liquid is increased as the magnets and helical screw have activated the dissolved oxygen in the liquid.

To hold lever 24 down and in the open position, liquid dispenser 10 may also include retention means connected to chamber 12 for retaining the activation means in the second position. Retention means may be a ring 46 connected to chamber 12 configured to slide over lever 24.

To fine tune the amount of liquid flowing through dispenser 10, a thumb wheel 35 threadedly connected to piston shaft 34 may also be provided. Thumb wheel 35 would be connected to piston shaft 34 on the outside of manifold body 16. By rotating thumb wheel 35, a user can minimally adjust the travel of piston 30 and consequently, the amount of liquid being dispensed.

While embodiments of the invention have been described and illustrated, such embodiments should be considered illustrative of the invention only. The invention may include variants not described or illustrated herein in detail. Thus, the embodiments described and illustrated herein should not be considered to limit the invention as construed in accordance with the accompanying claims.

What is claimed is:

1. A liquid dispenser comprising:
an elongated open-ended chamber body having a distal and proximal end, said proximal end configured to receive a stream of liquid and said distal end configured to expel said stream of liquid; and
a helical screw connected inside said elongated chamber body, said screw configured to transport said stream of liquid from said proximal end through to said distal end of said chamber body.

2. The liquid dispenser of claim 1 further comprising a magnets connected inside of said elongated chamber body and adjacent to said helical screw.

3. The liquid dispenser of claim 2 wherein said magnets is also connected adjacent to said proximal end of said chamber body.

4. The liquid dispenser of claim 1 further comprising activation means connected to said chamber body to inhibit said stream of liquid from flowing through said chamber body in a first position and to allow said stream of liquid to flow through said chamber body in a second position.

5. The liquid dispenser of claim 4 wherein said activation means comprises:
a lever pivotably connected to said chamber body;
a flow engagement device in mechanical communication with said lever and oriented in said chamber body to inhibit said stream of liquid from flowing inside said chamber body in said first position; and
a biaser to bias said flow engagement device into said first position.

6. The liquid dispenser of claim 5 further comprising retention means connected to said chamber body for retaining said activation means in said second position.

7. The liquid dispenser of claim 6 wherein said retention means comprises a ring connected to said chamber body and configured to slide over said lever.

8. A liquid dispenser comprising:
an elongated open-ended chamber body having a distal and proximal end, said proximal end configured to receive a stream of liquid and said distal end configured to expel said stream of liquid;
a helical screw connected inside said elongated chamber body, said screw configured to transport said stream of liquid from said proximal end through to said distal end of said chamber body; and
activation means connected to said chamber body to inhibit said stream of liquid from flowing through said chamber body in a first position and to allow said stream of liquid to flow through said chamber body in a second position.

9. The liquid dispenser of claim 8 further comprising a magnets connected inside of said elongated chamber body and adjacent to said helical screw.

10. The liquid dispenser of claim 9 wherein said magnets is also connected adjacent to said proximal end of said chamber body.

11. The liquid dispenser of claim 9 wherein said activation means comprises:
a lever pivotably connected to said chamber body;
a flow engagement device in mechanical communication with said lever and oriented in said chamber body to inhibit said stream of liquid from flowing inside said chamber body in said first position; and
a biaser to bias said flow engagement device into said first position.

12. The liquid dispenser of claim 11 further comprising retention means connected to said chamber body for retaining said activation means in said second position.

13. The liquid dispenser of claim 12 wherein said retention means comprises a ring connected to said chamber body and configured to slide over said lever.
